(19) United States
(12) Patent Application Publication
(10) Pub. No.: US 2022/0294196 A1
(43) Pub. Date: Sep. 15, 2022

(54) METHOD FOR PRODUCING AN ABLATED CONDUCTOR

(71) Applicants: Heraeus Deutschland GmbH & Co. KG, Hanau (DE); Heraeus Medical Components LLC, St. Paul, MN (US)

(72) Inventors: Jörg-Martin GEBERT, Hanau (DE); Ilias NIKOLAIDIS, Hanau (DE); Thomas LAUINGER, Hanau (DE); Paul SCHUSTER, St. Paul, MN (US); Stefan SCHIBLI, Hanau (DE)

(73) Assignees: Heraeus Deutschland GmbH & Co. KG, Hanau (DE); Heraeus Medical Components LLC, St. Paul, MN (US)

(21) Appl. No.: 17/200,201

(22) Filed: Mar. 12, 2021

(51) Int. Cl. H02G 1/12; B23K 26/36

(52) U.S. Cl. CPC H02G 1/128; B23K 26/36

(57) ABSTRACT

One aspect is a method for producing an ablated conductor, including providing a coated conductor including an inner layer that is electrically conducting and at least one coating layer that at least partially covers the inner layer, and providing at least one laser beam. The method includes at least partially removing the at least one coating layer in a first section by moving the at least one laser beam and the coated conductor with respect to each other along at least one scan line in the first section. A first energy density of a first radiation, produced by the at least one laser beam, that irradiates a surface of the first section is adjusted according to a first ablation depth of the first section.

### FIELD OF THE INVENTION

One aspect pertains to a method for producing an ablated conductor, including the steps of providing a coated conductor including an inner layer that is electrically conducting, and at least one coating layer that at least partially covers the inner layer, and providing at least one laser beam. The method includes at least partially removing the at least one coating layer in a first section by moving the at least one laser beam and the coated conductor with respect to each other along at least one scan line in the first section. A first energy density of a first radiation, produced by the at least one laser beam, that irradiates a surface of the first section is adjusted according to a first ablation depth of the first section. One aspect also pertains to an ablated conductor obtainable by the method. One aspect further pertains to a use of the ablated conductor.

### BACKGROUND

Ablated conductors are often used in applications such as electrochemical sensors. In particular, ablated conductors are comprised in medical devices used for measuring, such as blood glucose monitors. It is therefore very important that the ablated conductors have a low failure rate, and that the ablated conductors enable the taking of very high-precision measurements.

Ablated conductors are very often produced from coated conductors including at least one coating layer and an inner layer that is electrically conducting. In a large number of applications, it has been found that laser ablation is particularly suitable for producing ablated conductors. This is especially true if the coated conductors are very thin, for example, 100 mm. Such thin conductors are very often required in medical devices

There are a number of important requirements for a method for producing an ablated conductor. For example, it is very important that the ablation process does not damage the inner layer, or the coating layers that should not be removed. It is also important that when a coating layer is to be removed, that the correct thickness of the coating layer is removed. Furthermore, ablated conductors used for different purpose have very different requirements with regards to the coating layers that should be removed, for example, different ablation patterns, the thickness of the coating layers that should be removed, and the number of coating layers that should be removed. It is thus highly advantageous to have a method for producing an ablated conductor that can be easily adapted for different ablation requirements, while simultaneously being simple to perform. These requirements are particularly important for producing ablated conductors that have a low failure rate, and that allow for the taking of very high-precision measurements.

EP3033197 B1 discloses the ablation of a coating layer of a coated conductor. However, EP3033197 B1 teaches that the inner layer of the coated conductor should be damaged. U.S. Pat. No. 5,515,848 A also discloses the ablation of a coating layer of a coated conductor. However, U.S. Pat. No. 5,515,848 A also teaches that the coating layer should be damaged.

US2009/162531 A1 also discloses the ablation of a coating layer of a coated conductor. However, US2009/162531 A1 teaches that the whole coating layer should be removed in a section. Therefore, the disclosure of US2009/162531 A1 cannot be used to partially remove a coating layer. Nor can the disclosure of US2009/162531 A1 be used to only remove a single coating layer for a coated conductor including multiple coating layers.

For these and other reasons there is a need for the present invention.

### SUMMARY

An object one embodiment is to at least partially overcome at least one of the disadvantages encountered in the state of the art.

It is a further object of one embodiment to provide a method for producing an ablated conductor that reduces the damage to the inner layer and coating layers of the coated conductor used in the production of the ablated conductor.

It is a further object of one embodiment to provide a method for producing an ablated conductor that reduces the overheating of the inner layer of the coated conductor used in the production of the ablated conductor.

It is a further object of one embodiment to provide a method for producing an ablated conductor that has an improved performance for removing the required thickness of a coating layer of a coated conductor.

It is a further object of one embodiment to provide a method for producing an ablated conductor that requires less set-up time to adapt the method when producing ablated conductors with different ablation requirements, such as different ablation patterns, the thickness of the coating layers that should be removed, and the number of coating layers that should be removed.

It is a further object of one embodiment to provide a method for producing an ablated conductor that reduces energy consumption.

It is a further object of one embodiment to provide a method for producing an ablated conductor that reduces the requirement that the coated conductor, used in the production of the ablated conductor, should have a uniform coating layer. Here the uniform coating layer is the coating layer that should be ablated.

It is a further object of one embodiment to provide a method for producing an ablated conductor that reduces the time for producing the ablated conductor.

It is a further object of one embodiment to provide a method for producing an ablated conductor, wherein the ablated conductor has a reduced failure rate.

It is a further object of one embodiment to provide a method for producing an ablated conductor, wherein the ablated conductor has a higher precision when used in medical devices, and in particular as an electrochemical sensor of medical measuring devices.

It is a further object of one embodiment to provide a method for producing an ablated conductor, wherein the ablated conductor has an increased lifetime.

It is a further object of one embodiment to provide an ablated conductor that has a reduced failure rate.

It is a further object of one embodiment to provide an ablated conductor that has a higher precision when used in medical devices, and in particular as an electrochemical sensor of medical measuring devices.

It is a further object of one embodiment to provide an ablated conductor that has an increased lifetime.

### BRIEF DESCRIPTION OF THE FIGURES

The figures serve to exemplify the present embodiments, and should not be viewed as limiting the embodiments. Note that the figures are not drawn to scale.

FIGS. 1A and 1B: schematic illustrations of a first example of the method for producing an ablated conductor by adjusting an energy density of a radiation, produced by a laser beam, that irradiates a surface of a section of a coated conductor.

FIGS. 2A, 2B and 2C: schematic illustrations of a second example of the method for producing an ablated conductor by adjusting an energy density of a radiation, produced by a laser beam, that irradiates a surface of a section of a coated conductor.

FIG. 3: schematic illustration of a third example of the method for producing an ablated conductor by adjusting an energy density of a radiation, produced by a laser beam, that irradiates a surface of a section of a coated conductor.

FIGS. 4A and 4B: schematic illustrations of a first example of the method for producing an ablated conductor by adjusting an orientation angle of the laser beam that irradiates a surface of a section of a coated conductor.

FIGS. 5A and 5B: schematic illustrations of the definition of the ablation depth and orientation angle.

FIG. 6: flow diagram illustrating the steps of the method for producing an ablated conductor.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

A contribution to at least partially fulfilling at least one of the above-mentioned objects is made by any of the embodiments.

A first (1^{st}) embodiment is a first method for producing an ablated conductor, including the steps of:
a.) providing
   i.) a coated conductor including
      A.) an inner layer that is electrically conducting,
      B.) at least one coating layer that at least partially covers the inner layer;
   ii.) at least one laser beam;
b.) at least partially removing the at least one coating layer in a first section by moving the at least one laser beam and the coated conductor with respect to each other along at least one scan line in the first section;

wherein
a first energy density of a first radiation, produced by the at least one laser beam, that irradiates a surface of the first section is adjusted according to a first ablation depth of the first section.

In one variant of the first embodiment method for producing an ablated conductor, the first energy density is adjusted by adjusting the number of scan lines in the first section. This variant is a 2^{nd} embodiment, which depends on the 1^{st} embodiment.

In a variant of the first embodiment method for producing an ablated conductor, the first energy density is adjusted by adjusting the fluence of the at least one laser beam that irradiates the surface of the first section. This variant is a 3^{rd} embodiment, which depends on any of the 1^{st} to 2^{nd} embodiments.

In a variant of the first embodiment method for producing an ablated conductor, the method further comprises the step of at least partially removing the at least one coating layer in a further section by moving the at least one laser beam and the coated conductor with respect to each other along at least one scan line in the further section, and wherein a further energy density of a further radiation, produced by the at least one laser beam, that irradiates a surface of the further section is adjusted according to a further ablation depth of the further section. This variant is a 4^{th} embodiment, which depends on any of the 1^{st} to 3^{rd} embodiments.

In a variant of the first embodiment method for producing an ablated conductor, at least one or all of the following applies:
a.) the further energy density is adjusted by adjusting a number of scan lines in the further section;
b.) the further energy density is adjusted by adjusting a fluence of the at least one laser beam that irradiates the surface of the further section.

This variant is a 5^{th} embodiment, which depends on the 4^{th} embodiment. For the 5^{th} embodiment, all possible combination of the features a.) and b.) are embodiments. These combinations are e.g., a; b; a, b.

In a variant of the first embodiment method for producing an ablated conductor, at least one or all of the following applies:
a.) at least one physical dimension of the first section is less than 5%, in one embodiment less than 3%, and in one embodiment less than 1% larger than the corresponding physical dimension of the further section;
b.) the first ablation depth is in the range of 50% to 650%, in one embodiment in the range of 100% to 550%, and in one embodiment in the range of 150% to 450% larger than the further ablation depth;
c.) the first energy density is in the range of 50% to 350%, in one embodiment in the range of 100% to 250%, and further in one embodiment in the range of 150% to 200% larger than the further energy density;
d.) the number of scan lines in the first section is at least 1.5 times, in one embodiment at least 2 times, more in one embodiment at least 3 times, and further in one embodiment at least 4 times larger than the number of scan lines in the further section;
e.) the fluence of the laser beam in the first section is at least 50%, in one embodiment at least 75%, more in one embodiment at least 100%, and further in one embodiment at least 150% larger than a fluence of the larger beam in the further section.

This variant is a 6^{th} embodiment, which depends on any of the 4^{th} to 5^{th} embodiments. For the 6^{th} embodiment, all possible combination of the features a.) to e.) are embodiments. These combinations are e.g., a; b; c; d; e; a, b; a, c; a, d; a, e; b, c; b, d; b, e; c, d; c, e; d, e; a, b, c; a, b, d; a, b, e; a, c, d; a, c, e; a, d, e; b, c, d; b, c, e; b, d, e; c, d, e; a, b, c, d; a, b, c, e; a, b, d, e; a, c, d, e; b, c, d, e; a, b, c, d, e. In an aspect of the 6^{th} embodiment, examples of the at least one physical dimension include a length, a width, and an arc length.

In a variant of the first embodiment method for producing an ablated conductor, the method further comprises the step of rotating the coated conductor, in one embodiment by an angle in the range of 20° to 180°, in one embodiment by an angle in the range of 40° to 150°, and in one embodiment by an angle in the range of 60° to 120°. An angle of 90° is particularly preferred. This variant is a 7^{th} embodiment, which depends on any of the 1^{st} to 6^{th} embodiments. In an aspect of the 7^{th} embodiment, it is preferred to rotate the coated conductor after at least partially removing the outermost coating layer in the first section, the further section, or both.

In a variant of the first embodiment method for producing an ablated conductor, the at least one laser beam is a polarized laser beam, in one embodiment a linearly polarized laser beam. This variant is an 8^{th} embodiment, which depends on any of the 1^{st} to 7^{th} embodiments.

In a variant of the first embodiment method for producing an ablated conductor, at least one or all of the following applies:
a.) a first orientation angle of the at least one laser beam, that irradiates a surface of the first section, is adjusted according to the first ablation depth of the first section;
b.) the first orientation angle is in the range of 0° to 82°, in one embodiment in the range of 10° to 78°, in one embodiment in the range of 20° to 74°, and in one embodiment in the range of 28° to 74°;
c.) a further orientation angle of the at least one laser beam, that irradiates a surface of the further section, is adjusted according to the further ablation depth of the further section;
d.) the further orientation angle is in the range of 35° to 90°, in one embodiment in the range of 40° to 90°, in one embodiment in the range of 45° to 90°, and in one embodiment in the range of 52° to 90°;
e.) the first orientation angle is at least 20%, in one embodiment at least 40%, and in one embodiment at least 60% smaller than the further orientation angle.

This variant is a 9^{th} embodiment, which depends on the 8^{th} embodiments. For the 9^{th} embodiment, all possible combination of the features a.) to e.) are embodiments of the variant. These combinations are e.g., a; b; c; d; e; a, b; a, c; a, d; a, e; b, c; b, d; b, e; c, d; c, e; d, e; a, b, c; a, b, d; a, b, e; a, c, d; a, c, e; a, d, e; b, c, d; b, c, e; b, d, e; c, d, e; a, b, c, d; a, b, c, e; a, b, d, e; a, c, d, e; b, c, d, e; a, b, c, d, e.

A tenth (10^{th}) embodiment is a further method for producing an ablated conductor, including the steps of:
a.) providing
   i.) a coated conductor including
      A.) an inner layer that is electrically conducting,
      B.) at least one coating layer that at least partially covers the inner layer;
   ii.) at least one polarized laser beam, in one embodiment a linearly polarized laser beam;
b.) at least partially removing the at least one coating layer in a first section by moving the at least one laser beam and the coated conductor with respect to each other along at least one scan line in the first section;

wherein
a first orientation angle of the at least one laser beam, that irradiates a surface of the first section, is adjusted according to a first ablation depth of the first section.

In a variant of the further method for producing an ablated conductor, the method further comprises the step of at least partially removing the at least one coating layer in a further section by moving the at least one laser beam and the coated conductor with respect to each other along at least one scan line in the further section, and wherein a further orientation angle of the at least one laser beam, that irradiates a surface of the further section, is adjusted according to a further ablation depth of the further section. This variant is an 11^{th} embodiment, which depends on the 10^{th} embodiment.

In a variant of the further method for producing an ablated conductor, at least one or all of the following applies:
a.) the first orientation angle is in the range of 0° to 82°, in one embodiment in the range of 10° to 78°, in one embodiment in the range of 20° to 74°, and in one embodiment in the range of 28° to 74°;
b.) the further orientation angle is in the range of 35° to 90°, in one embodiment in the range of 40° to 90°, in one embodiment in the range of 45° to 90°, and in one embodiment in the range of 52° to 90°;
c.) the first orientation angle is at least 20%, in one embodiment at least 40%, and in one embodiment at least 60% smaller than the further orientation angle.

This variant is a 12^{th} embodiment, which depends on any of the 10^{th} to 11^{th} embodiments. For the 12^{th} embodiment, all possible combination of the features a.) to c.) are embodiments of the variant. These combinations are e.g., a; b; c; a, b; a, c; b, c; a, b, c.

In a variant of the further method for producing an ablated conductor, at least one or all of the following applies:
a.) a first energy density of a first radiation, produced by the at least one laser beam, that irradiates the surface of the first section is adjusted according to the first ablation depth;
b.) a further energy density of a further radiation, produced by the at least one laser beam, that irradiates a surface of the further section is adjusted according to the further ablation depth.

This variant is a 13^{th} embodiment, which depends on any of the 10^{th} to 12^{th} embodiments. For the 13^{th} variant, all possible combination of the features a.) and b.) are embodiments of the variant. These combinations are e.g., a; b; a, b.

In a variant of the further method for producing an ablated conductor, at least one or all of the following applies:
a.) the first energy density is adjusted by adjusting a number of scan lines in the first section;
b.) the further energy density is adjusted by adjusting a number of scan lines in the further section.

This variant is a 14^{th} embodiment, which depends on the 13^{th} embodiment. For the 14^{th} variant, all possible combination of the features a.) and b.) are embodiments of the variant. These combinations are e.g., a; b; a, b.

In a variant of the further method for producing an ablated conductor, at least one or all of the following applies:
a.) the first energy density is adjusted by adjusting a fluence of the at least one laser beam that irradiates the surface of the first section;
b.) the further energy density is adjusted by adjusting a fluence of the at least one laser beam that irradiates the surface of the further section.

This variant is a 15^{th} embodiment, which depends on any of the 13^{th} to 14^{th} embodiments. For the 15^{th} variant, all possible combination of the features a.) and b.) are embodiments of the variant. These combinations are e.g., a; b; a, b.

In a variant of the further method for producing an ablated conductor, at least one or all of the following applies:
a.) at least one physical dimension of the first section is less than 5%, in one embodiment less than 3%, and in one embodiment less than 1% larger than the corresponding physical dimension of the further section;
b.) the first ablation depth is in the range of 50% to 650%, in one embodiment in the range of 100% to 550%, and in one embodiment in the range of 150% to 450% larger than the further ablation depth;
c.) the first energy density is in the range of 50% to 350%, in one embodiment in the range of 100% to 250%, and in one embodiment in the range of 150% to 200% larger than the further energy density;
d.) the number of scan lines in the first section is at least 1.5 times, in one embodiment at least 2 times, in one embodiment at least 3 times, and in one embodiment at least 4 times larger than the number of scan lines in the further section;
e.) the fluence of the laser beam in the first section is at least 50%, in one embodiment at least 75%, in one embodiment at least 100%, and in one embodiment at least 150% larger than a fluence of the larger beam in the further section.

This variant is a 16^{th} embodiment, which depends on any of the 11^{th} to 15^{th} embodiments. For the 16^{th} variant, all possible combination of the features a.) to e.) are embodiments of the variant. These combinations are e.g., a; b; c; d; e; a, b; a, c; a, d; a, e; b, c; b, d; b, e; c, d; c, e; d, e; a, b, c; a, b, d; a, b, e; a, c, d; a, c, e; a, d, e; b, c, d; b, c, e; b, d, e; c, d, e; a, b, c, d; a, b, c, e; a, b, d, e; a, c, d, e; b, c, d, e; a, b, c, d, e. In a variant of the 16^{th} embodiment, examples of the at least one physical dimension include a length, a width, and an arc length.

In a variant of the further method for producing an ablated conductor, the method further comprises the step of rotating the coated conductor, in one embodiment by an angle in the range of 20° to 180°, in one embodiment by an angle in the range of 40° to 150°, and in one embodiment by an angle in the range of 60° to 120°. An angle of 90° is particularly preferred. This variant is a 17^{th} embodiment, which depends on any of the 10^{th} to 16^{th} embodiments. In a variant of the 17^{th} embodiment, it is preferred to rotate the coated conductor after at least partially removing the outermost coating layer in the first section, the further section, or both.

In variants of the first and further methods for producing an ablated conductor, the coated conductor comprises at least two coating layers, and wherein the at least two coating layers are at least one intermediate coating layer and an outermost coating layer, and wherein at least one or all of the following applies:
a.) the at least one intermediate coating layer at least partially covers, in one embodiment at least partially surrounds, the inner layer;
b.) the outermost coating layer at least partially covers, in one embodiment at least partially surrounds, the at least one intermediate coating layer. It is further preferred that the outermost coating layer at least partially covers, in one embodiment at least partially surrounds, the inner layer.

This variant is an 18^{th} embodiment, which depends on at least one or all of the following: the first method for producing an ablated conductor, in one embodiment any of the 1^{st} to 9^{th} variants, and the further method for producing an ablated conductor, in one embodiment any of the 10^{th} to 17^{th} variants. For the 18^{th} variant, all possible combination of the features a.) and b.) are embodiments of the variant. These combinations are e.g., a; b; a, b.

In variants of the first and further methods for producing an ablated conductor, the inner layer has at least one or all of the following properties:
a.) comprises one or more metals selected from the group consisting of gold, platinum, copper, silver, tantalum, and stainless steel, in one embodiment platinum clad tantalum;
b.) a thickness in the range of 40 μm to 160 μm, in one embodiment in the range of 60 μm to 140 μm, and more in one embodiment in the range of 80 μm to 120 μm;
c.) an electrical conductivity in the range of 10⁴ S/m to 10⁸ S/m, in one embodiment in the range of 10⁵ S/m to 5×10⁷ S/m, and in one embodiment in the range of 5×10⁵ S/m to 2×10⁷ S/m.

This variant is a 19^{th} embodiment, which depends on at least one or all of the following: the first method for producing an ablated conductor, in one embodiment any of the 1^{st} to 9^{th} variants, the further method for producing an ablated conductor, in one embodiment any of the 10^{th} to 17^{th} embodiments, and the 18^{th} embodiment. For the 19^{th} embodiment, all possible combination of the features a.) to c.) are embodiments of the variant. These combinations are e.g., a; b; c; a, b; a, c; b, c; a, b, c. In an aspect of the 19^{th} embodiment, if the coated conductor is a wire, it is preferred that the “thickness” is a diameter of the inner layer.

In variants of the first and further methods for producing an ablated conductor, the at least one intermediate coating layer has at least one or all of the following properties:
a.) a thickness in the range of 10 μm to 40 μm, in one embodiment in the range of 15 μm to 35 μm, and in one embodiment in the range of 20 μm to 30 μm;
b.) comprises a polymer, in one embodiment polyurethane;
c.) an electrical conductivity in the range of 10⁻²¹ S/m to 10⁻¹¹ S/m, in one embodiment in the range of 10⁻²⁰ S/m to 10⁻¹² S/m, and in one embodiment in the range of 5×10⁻²⁰ S/m to 2×10⁻¹³ S/m.

This variant is a 20^{th} embodiment, which depends on any of the 18^{th} to 19^{th} embodiments. For the 20^{th} variant, all possible combination of the features a.) to c.) are embodiments of the variant. These combinations are e.g., a; b; c; a, b; a, c; b, c; a, b, c.

In variants of the first and further methods for producing an ablated conductor, the outermost coating layer has at least one or all of the following properties:
a.) comprises at least 10 wt. %, in one embodiment at least 25 wt. %, in one embodiment at least 50 wt. %, and particularly preferred at least 80 wt. %, based on the total weight of the outermost layer, of an organic material;
b.) comprises 50 wt. %, in one embodiment 60 wt. %, in one embodiment 70 wt. %, based on the total weight of the outer layer, of a metal or a metal compound, or a combination thereof. A preferred metal is silver. A preferred metal compound is silver chloride;
c.) a thickness in the range of 6 μm to 24 μm, in one embodiment in the range of 9 μm to 21 μm, and in one embodiment in the range of 12 μm to 18 μm;
d.) an electrical conductivity in the range of 10⁻⁸ S/m to 2×10⁻² S/m, in one embodiment in 5 the range of 10⁻⁷ S/m to 10⁻³ S/m, and in one embodiment in the range of 5×10⁻⁷ S/m to 2×10⁻⁴ S/m.

This variant is a 21st embodiment, which depends on any of the 18^{th} to 20^{th} embodiments. For the 21^{st} variant, all possible combination of the features a.) to d.) are embodiments of the variant. These combinations are e.g., a; b; c; d; a, b; a, c; a, d; b, c; b, d; c, d; a, b, c; a, b, d; a, c, d; b, c, d; a, b, c, d.

In preferred variants of the first and further methods for producing an ablated conductor, the organic material is a polymer selected from the group consisting of:
a.) a mixture including an electrically insulating polymer and a plurality of particles that comprises a metal or a metal compound, or a combination thereof, wherein the particles are in one embodiment powder or fibres, wherein the particles in one embodiment consist of one or more metals or metal compounds, in one embodiment a metal salt, in one embodiment a metal halide, and particular preferred a metal chloride, or a combination thereof, in one embodiment a combination of silver and silver chloride;
b.) a conductive polymer; or
c.) a combination of a.) and b.).

This variant is a 22^{nd} embodiment, which depends on the 21^{st} embodiment. For the 22^{nd} variant, all possible combination of the features a.) to c.) are embodiments of the variant. These combinations are e.g., a; b; c; a, b; a, c; b, c; a, b, c.

In variants of the first and further methods for producing an ablated conductor, at least one laser beam is a laser beam of the first kind, wherein a laser beam of the first kind has at least one or all of the following properties:
a.) a pulse duration in the range of 10 fs to 500 ns, in one embodiment in the range of 50 fs to 400 ns, in one embodiment in the range of 100 fs to 300 ns, in one embodiment in the range of 500 fs to 200 ns, in one embodiment in the range of 1 ns to 100 ns, in one embodiment in the range of 10 ns to 100 ns, in one embodiment in the range of 15 ns to 80 ns;
b.) a pulse frequency in the range of 5 kHz to 600 kHz, in one embodiment in the range of 10 kHz to 500 kHz, in one embodiment in the range of 20 kHz to 500 kHz, in one embodiment in the range of 30 kHz to 450 kHz, in one embodiment in the range of 40 kHz to 400 kHz, in one embodiment in the range of 50 kHz to 350 kHz, in one embodiment in the range of 80 kHz to 300 kHz, in one embodiment in the range of 90 kHz to 250 kHz, in one embodiment in the range of 100 kHz to 200 kHz, in one embodiment in the range of 110 kHz to 190 kHz;
c.) an energy per pulse in the range of 2 μJ to 15 μJ, in one embodiment in the range of 2 μJ to 13 μJ, in one embodiment in the range of 3 μJ to 10 μJ, in one embodiment in the range of 4 μJ to 8 μJ;
d.) has a spectrum with a peak wavelength in the range of 430 nm to 780 nm, in one embodiment in the range of 430 nm to 640 nm, in one embodiment in the range of 430 nm to 600 nm, in one embodiment in the range of 490 nm to 600 nm, in one embodiment in the range of 490 nm to 570 nm, in one embodiment in the range of 500 nm to 560 nm, in one embodiment in the range of 510 nm to 550 nm, in one embodiment in the range of 520 nm to 540 nm, in one embodiment in the range of 525 nm to 540 nm, in one embodiment in the range of 528 nm to 536 nm;
e.) a fluence in the range of 1.0 J/cm² to 5.0 J/cm², in one embodiment in the range of 1.5 J/cm² to 4.5 J/cm², in one embodiment in the range of 2.0 J/cm² to 4.0 J/cm², in one embodiment in the range of 2.5 J/cm² to 3.8 J/cm²; f) a spot size in the range of 5 μm to 50 μm, in one embodiment in the range of 5 μm to 40 μm, in one embodiment in the range of 5 μm to 30 μm, and in one embodiment in the range of 10 μm to 20 μm.

This variant is a 23^{rd} embodiment, which depends on at least one or all of the following: the first method for producing an ablated conductor, any of the 1^{st} to 9^{th} embodiments, the further method for producing an ablated conductor, in any of the 10^{th} to 17^{th} embodiment, and any of the 18^{th} to 22^{nd} embodiment. For the 23^{rd} embodiment, all possible combination of the features a.) to f) are embodiments of the variant. These combinations are e.g., a; b; c; d; e; f; a, b; a, c; a, d; a, e; a, f; b, c; b, d; b, e; b, f; c, d; c, e; c, f; d, e; d, f; e, f; a, b, c; a, b, d; a, b, e; a, b, f; a, c, d; a, c, e; a, c, f; a, d, e; a, d, f; a, e, f; b, c, d; b, c, e; b, c, f; b, d, e; b, d, f; b, e, f; c, d, e; c, d, f; c, e, f; d, e, f; a, b, c, d; a, b, c, e; a, b, c, f; a, b, d, e; a, b, d, f; a, b, e, f; a, c, d, e; a, c, d, f; a, c, e, f; a, d, e, f; b, c, d, e; b, c, d, f; b, c, e, f; b, d, e, f; c, d, e, f; a, b, c, d, e; a, b, c, d, f; a, b, c, e, f; a, b, d, e, f; a, c, d, e, f; b, c, d, e, f; a, b, c, d, e, f;

In variants of the first and further methods for producing an ablated conductor, at least one laser beams is a laser beam of the further kind, wherein a laser beam of the further kind has at least one or all of the following properties:
a.) a pulse duration in the range of 10 fs to 500 ns, in one embodiment in the range of 50 fs to 400 ns, in one embodiment in the range of 100 fs to 300 ns, in one embodiment in the range of 500 fs to 200 ns, in one embodiment in the range of 1 ns to 100 ns, in one embodiment in the range of 1 ns to 50 ns, in one embodiment in the range of 5 ns to 30 ns, in one embodiment in the range of 10 ns to 20 ns;
b.) a pulse frequency in the range of 1 kHz to 100 kHz, in one embodiment in the range of 10 kHz to 80 kHz, in one embodiment in the range of 20 kHz to 60 kHz;
c.) an energy per pulse in the range of 1 μJ to 50 μJ, in one embodiment in the range of 5 μJ to 40 μJ, in one embodiment in the range of 10 μJ to 30 μJ, in one embodiment in the range of 10 μJ to 25 μJ, in one embodiment in the range of 10 μJ to 20 μJ, in one embodiment in the range of 12 μJ to 18 μJ, in one embodiment in the range of 14 to 16 μJ;
d.) has a spectrum with a peak wavelength in the range of 10 nm to 430 nm, in one embodiment in the range of 100 nm to 430 nm, in one embodiment in the range of 150 nm to 430 nm, in one embodiment in the range of 180 nm to 400 nm, in one embodiment in the range of 200 nm to 400 nm, in one embodiment in the range of 220 nm to 400 nm, in one embodiment in the range of 220 nm to 380 nm;
e.) a fluence in the range of 0.1 J/cm² to 50.0 J/cm², in one embodiment in the range of 0.2 J/cm² to 30.0 J/cm², in one embodiment in the range of 0.3 J/cm² to 20.0 J/cm²;
f) a spot size in the range of 2 μm to 50 μm, in one embodiment in the range of 2 μm to 40 μm, in one embodiment in the range of 5 μm to 30 μm, in one embodiment in the range of 5 μm to 20 μm, and in one embodiment in the range of 5 μm to 15 μm.

This variant is a 24^{th} embodiment, which depends on at least one or all of the following: the first method for producing an ablated conductor, any of the 1^{st} to 9^{th} embodiment, the further method for producing an ablated conductor, any of the 10^{th} to 17^{th} embodiment, and any of the 18^{th} to 23^{rd} embodiment. For the 24^{th} embodiment, all possible combination of the features a.) to f.) are embodiments of the variant. These combinations are e.g., a; b; c; d; e; f; a, b; a, c; a, d; a, e; a, f; b, c; b, d; b, e; b, f; c, d; c, e; c, f; d, e; d, f; e, f; a, b, c; a, b, d; a, b, e; a, b, f; a, c, d; a, c, e; a, c, f; a, d, e; a, d, f; a, e, f; b, c, d; b, c, e; b, c, f; b, d, e; b, d, f; b, e, f; c, d, e; c, d, f; c, e, f; d, e, f; a, b, c, d; a, b, c, e; a, b, c, f; a, b, d, e; a, b, d, f; a, b, e, f; a, c, d, e; a, c, d, f; a, c, e, f; a, d, e, f; b, c, d, e; b, c, d, f; b, c, e, f; b, d, e, f; c, d, e, f; a, b, c, d, e; a, b, c, d, f; a, b, c, e, f; a, b, d, e, f; a, c, d, e, f; b, c, d, e, f; a, b, c, d, e, f In one aspect of the 24^{th} embodiment, it is particularly preferred that a laser beam of the further kind has a spectrum with a peak wavelength in the range of 220 nm to 280 nm, in one embodiment in the range of 230 nm to 260 nm; or in the range of 300 nm to 400 nm, in one embodiment in the range of 330 nm to 380 nm. In the 24th embodiment, it is preferred that the fluence of a laser beam of the further kind is in the range of 0.1 J/cm² to 50.0 J/cm², in one embodiment in the range of 0.2 J/cm² to 30.0 J/cm². In another aspect of the 24^{th} embodiment, it is further preferred that the fluence of a laser beam of the further kind is in the range of 1 J/cm² to 20.0 J/cm², in one embodiment in the range of 11 J/cm² to 18 J/cm², in one embodiment in the range of 12.0 J/cm² to 17.0 J/cm².

In variants of the first and further methods for producing an ablated conductor, the at least one laser beam is obtainable from at least one solid-state laser. This variant is a 25^{th} embodiment, that in one embodiment depends on at least one or all of the following: the first method for producing an ablated conductor, in any of the 1^{st} to 9^{th} embodiment, the further method for producing an ablated conductor, any of the 10^{th} to 17^{th} embodiment, and any of the 18^{th} to 24^{th} embodiment.

A twenty-sixth (26^{th}) embodiment is an ablated conductor obtainable by a method according to the embodiment, wherein the ablated conductor comprises an inner layer, in one embodiment an inner layer and at least one coating layer. For the 26^{th} variant, it is preferred that the ablated conductor is obtainable by at least one or all of the following: the first method for producing an ablated conductor, any of the 1^{st} to 9^{th} embodiments, the further method for producing an ablated conductor, any of the 10^{th} to 17^{th} embodiments, and any of the 18^{th} to 25^{th} embodiments.

In a variant of the ablated conductor according to the embodiment, the ablated conductor has at least one or all of the following properties:
a.) a diameter in the range of 40 μm to 240 μm, in one embodiment in the range of 60 μm to 220 μm, and in one embodiment in the range of 80 μm to 200 μm;
b.) a length of at least 2000 m, in one embodiment at least 6000 m, and in one embodiment at least 10 000 m.

This variant is a 27^{th} embodiment, which depends on the 26^{th} embodiment. For the 27^{th} variant, all possible combination of the features a.) and b.) are embodiments of the variant. These combinations are e.g., a; b; a, b.

In a variant of the ablated conductor according to the embodiment, the ablated conductor comprises at least two coating layers, and wherein the at least two coating layers are at least one intermediate coating layer and an outermost coating layer, and wherein at least one or all of the following applies:
a.) the at least one intermediate coating layer that at least partially covers, in one embodiment at least partially surrounds, the inner layer;
b.) the outermost coating layer that at least partially covers, in one embodiment at least partially surrounds, the at least one intermediate coating layer. It is further preferred that the outermost coating layer at least partially covers, in one embodiment at least partially surrounds, the inner layer.

This variant is a 28^{th} embodiment, which depends on any of the 26^{th} to 27^{th} embodiments. For the 28^{th} variant, all possible combination of the features a.) and b.) are embodiments of the variant. These combinations are e.g., a; b; a, b.

In a variant of the ablated conductor according to the embodiment, the inner layer of the ablated conductor has at least one or all of the following properties:
a.) comprises one or more metals selected from the group consisting of gold, platinum, copper, silver, tantalum, and stainless steel, in one embodiment platinum clad tantalum;
b.) a diameter in the range of 40 μm to 160 μm, in one embodiment in the range of 60 μm to 140 μm, and in one embodiment in the range of 80 μm to 120 μm;
c.) an electrical conductivity in the range of 10⁴ S/m to 10⁸ S/m, in one embodiment in the range of 10⁵ S/m to 5×10⁷ S/m, and in one embodiment in the range of 5×10⁵ S/m to 2×10⁷ S/m.

This variant is a 29^{th} embodiment, which depends on any of the 26^{th} to 28^{th} embodiments. For the 29^{th} variant, all possible combination of the features a.) to c.) are embodiments of the variant. These combinations are e.g., a; b; c; a, b; a, c; b, c; a, b, c.

In a variant of the ablated conductor according to the embodiment, the ablated conductor has an outermost coating layer that has at least one or all of the following properties:
a.) comprises at least 10 wt. %, in one embodiment at least 25 wt. %, in one embodiment at least 50 wt. %, and particularly preferred at least 80 wt. %, based on the total weight of the outermost coating layer, of an organic material;
b.) comprises 50 wt. %, in one embodiment 60 wt. %, in one embodiment 70 wt. %, based on the total weight of the outermost coating layer, of a metal or a metal compound, or a combination thereof. A preferred metal is silver. A preferred metal compound is silver chloride;
c.) a thickness in the range of 6 μm to 24 μm, in one embodiment in the range of 9 μm to 21 μm, and in one embodiment in the range of 12 μm to 18 μm;
d.) an electrical conductivity in the range of 10⁻⁸ S/m to 2×10⁻² S/m, in one embodiment in 5 the range of 10⁻⁷ S/m to 10⁻³ S/m, and in one embodiment in the range of 5×10⁻⁷ S/m to 2×10⁻⁴ S/m.

This variant is a 30^{th} embodiment, which depends on any of the 26^{th to} 29^{th} embodiments. For the 30^{th} variant, all possible combination of the features a.) to d.) are embodiments of the variant. These combinations are e.g., a; b; c; d; a, b; a, c; a, d; b, c; b, d; c, d; a, b, c; a, b, d; a, c, d; b, c, d; a, b, c, d.

In a variant of the ablated conductor according to the embodiment, the ablated conductor comprises an outermost coating layer, wherein the outermost coating layer comprises an organic material, wherein the organic material is a polymer selected from the group consisting of:
a.) a mixture including an electrically insulating polymer and a plurality of particles that comprises a metal or a metal compound, or a combination thereof, wherein the particles are in one embodiment powder or fibres, wherein the particles in one embodiment consist of one or more metals or metal compounds, in one embodiment a metal salt, in one embodiment a metal halide, and particular preferred a metal chloride, or a combination thereof, in one embodiment a combination of silver and silver chloride;
b.) a conductive polymer; or
c.) a combination of a.) and b.)

This variant is a 31^{st} embodiment, which depends on the 30^{th} embodiment. For the 31^{st} variant, all possible combination of the features a.) to c.) are embodiments of the variant. These combinations are e.g., a; b; c; a, b; a, c; b, c; a, b, c.

In a variant of the ablated conductor according to the embodiment, the ablated conductor comprises at least one intermediate coating layer that has at least one or all of the following properties:
a.) a thickness in the range of 10 μm to 40 μm, in one embodiment in the range of 15 μm to 35 μm, and in one embodiment in the range of 20 μm to 30 μm;
b.) comprises a polymer, in one embodiment polyurethane;
c.) an electrical conductivity in the range of 10⁻²¹ S/m to 10⁻¹¹ S/m, in one embodiment in the range of 10⁻²⁰ S/m to 10⁻¹² S/m, and in one embodiment in the range of 5×10⁻²⁰ S/m to 2×10⁻¹³ S/m.

This variant is a 32^{nd} embodiment, which depends on any of the 26^{th} to 31^{st} embodiment. For the 32^{nd} embodiment, all possible combination of the features a.) to c.) are embodiments of the variant. These combinations are e.g., a; b; c; a, b; a, c; b, c; a, b, c.

A thirty-third (33^{rd}) embodiment is a use of an ablated conductor according to the embodiment in an electrical device, in one embodiment a medical device, in one embodiment a medical device used for measuring, and further in one embodiment a medical device used for measuring blood glucose levels. It is preferred that the ablated conductor of the 33^{rd} embodiment is an ablated conductor according to any of the 26^{th} to 32^{nd} embodiments.

A thirty-fourth (34^{th}) embodiment is a use of an ablated conductor according to the embodiment as a sensor, in one embodiment an electrochemical sensor, in one embodiment an electrochemical sensor for a medical device used for measuring, and further in one embodiment an electrochemical sensor for a medical device used for measuring blood glucose levels. It is preferred that the ablated conductor of the 34^{th} embodiment is an ablated conductor according to any of the 26^{th} to 32^{nd} embodiments.

A thirty-fifth (35^{th}) embodiment is an electrical device including a further electronic element that is in electrical contact with an ablated conductor according to the embodiment. It is preferred that the ablated conductor of the 35^{th} variant is an ablated conductor according to any of the 26^{th} to 32^{nd} embodiments.

A thirty-sixth (36^{th}) embodiment is an electrical device, wherein the electrical device is selected from the group consisting of measuring devices, medical devices, or a combination thereof. It is preferred that the electrical device is one of the following: a continuous glucose monitor, an electrocardiograph, an electromyograph, or an electroencephalogram device. It is preferred that the electrical device of the 36^{th} variant is an electrical device according to the 35^{th} embodiment.

Further details regarding the embodiments can be found below. Examples of a “coating layer” are an outermost coating layer or an at least one intermediate coating layer.

### Ablated Conductor

An “ablated conductor” is defined as a product that is obtained once the ablation steps of the claimed method, including the repetitions of any of the ablation steps, have been completed.

### Layers Covering Each Other

If a further layer, e.g., an outermost coating layer, at least partially “covers” a first layer, e.g., an inner layer, this should be understood to mean that, when the coated conductor is viewed from at least one direction, the further layer at least partially obscures the first layer from view. In one embodiment, it is preferred that the first layer and the further layer touch each other. It is equally preferred that the first layer and the further layer do not touch each other.

### Removing the Coating Layer

In one embodiment, it is preferred to at least partially remove at least one coating layer in a section by moving at least one laser beam and a coated conductor with respect to each other along at least one scan line in the section. In this embodiment it is preferred to move the at least one laser beam while keeping the coated conductor stationary. In this embodiment it is also preferred to keep the at least one laser beam stationary while moving the coated conductor. In this embodiment it is also preferred to move both the at least one laser beam and the coated conductor.

In another embodiment, it is preferred that the coated conductor comprises at least two coating layers, e.g., a first coating layer and a further coating layer, wherein the further coating layer at least partially covers the first coating layer. An example of a first coating layer is an intermediate coating layer. An example of a further coating layer is an outermost coating layer. In another embodiment, it is preferred to at least partially remove the at least two coating layers in a section by moving the at least one laser beam and the coated conductor with respect to each other along at least one scan line in the section. In this embodiment, it is preferred to at least partially simultaneously remove the at least two coating layers. In this embodiment, it is also preferred to first at least partially remove a first coating layer, followed by at least partially removing a further coating layer.

In an embodiment, it is preferred that the at least one coating layer is at least partially removed in at least two sections. In this embodiment it is preferred to at least partially remove the at least one coating layer at least partially simultaneously in the at least two sections. In this embodiment, it is also preferred to at least partially remove the at least one coating layer in the at least two sections at different times.

### Scan Line

When moving the at least one laser beam and the coated conductor with respect to each other, the at least one laser beam will trace a path in space in the rest frame of the coated conductor. This path is defined as a “scan line”. In an embodiment, it is preferred that the path is traced on a surface of a section of the coated conductor. In an embodiment, it is preferred that the at least one laser beam does not change direction along a scan line.

In an embodiment, it is preferred to use a larger number of scan lines for a larger ablation depth, and to use a smaller number of scan lines for a smaller ablation depth. E.g., for a section with an ablation depth of 10 mm, it is preferred to use 5 scan lines, while for a section with an ablation depth of 20 mm, it is preferred to use 10 scan lines.

### Section of Coating Layer

When at least partially removing a coating layer in a “section”, the “section” should be understood to mean an area of the coating layer, which is to be at least partially removed, and where at least one production parameter is varied by less than 7%, in one embodiment by less than 4%, and in one embodiment by less than 1% during the at least partial removal of the coating layer. Examples of production parameters include the number of scan lines per unit area of the surface of the section, the fluence of the at least one laser beam, the speed with which the at least one laser beam moves along a scan line, an orientation angle of a polarization plane of the at least one laser beam. E.g., the coating layer is to be removed in a first section and a further section. The at least one laser beam has a first fluence when removing the coating layer in the first section. The at least one laser beam has a further fluence, not equal to the first fluence, when removing the coating layer in the further section.

In an embodiment, it is preferred to at least partially remove the at least one coating layer in at least two sections, e.g., a first section and a further section. In this embodiment it is preferred that the at least two sections have different ablation depths. In this embodiment it is preferred that a first section, of the at least two sections, is chosen as the section with the largest ablation depth, while a further section, of the at least two sections, is chosen as the section with the smallest ablation depth.

### Ablation Depth

An “ablation depth” should be understood to mean an average thickness of a section of the coating layer that is to be at least partially removed. It is not required that the “ablation depth” should be equal to a total thickness of the coating layer. E.g., a coating layer has a total thickness of 1 mm. It is desired to reduce the total thickness of the coating layer to 0.7 mm by removing an “ablation depth” of 0.3 mm of the coating layer. E.g., a coating layer has a total thickness of 1 mm. It is desired to completely remove the coating layer by removing an “ablation depth” of 1 mm of the coating layer. It is preferred that the ablation depth is measured along an imaginary axis that is fixed. This should be understood to mean that it is preferred to use the same imaginary axis when measuring the different ablation depth for different sections, i.e., the ablation depth for different sections is in one embodiment not measured along different coordinate axes.

### Energy Density

In an embodiment, it is preferred to adjust an energy density of a radiation, produced by the at least one laser beam, that irradiates a surface of a section by adjusting a number of scan lines in the section. In this embodiment it is preferred that a distance between any pair of adjacent scan lines in the section varies by less than 7%, in one embodiment by less than 4%, and in one embodiment by less than 1% from the average distance between adjacent scan lines in the section. In an embodiment, it is preferred to use a larger energy density for a larger ablation depth, and to use a smaller energy density for a smaller ablation depth, e.g., the energy density is increased with an increase in ablation depth.

In an embodiment, it is preferred that the energy density (e.g., a first energy density a further energy density) of the radiation, produced by the at least one laser beam, that irradiates the surface of the section of the coated conductor is in the range of 0.1 J/cm² to 100 J/cm², in one embodiment in the range of 1 J/cm² to 50 J/cm², in one embodiment in the range of 3 J/cm² to 25 J/cm², and in one embodiment in the range of 5 J/cm² to 10 J/cm².

In another embodiment, when at least partially removing the at least one coating layer in at least two sections, it is preferred that the energy density of the radiation is adjusted between the at least two sections. In this embodiment it is preferred to use at least two different laser beams with different properties to ablate the at least two sections. E.g., a first laser beam with first properties is used to ablate a first section, and a further laser beam with further properties is used to ablate a further section. In this embodiment it is equally preferred to adjust the properties of at least one laser beam between the ablation of a first section, of the at least two sections, and the ablation of a further section, of the at least two sections. E.g., a first laser beam with first properties is used to ablate a first section, and the first laser beam with further properties is used to ablate a further section. Example of the laser beam properties are a pulse duration, a pulse frequency, an energy per pulse, a peak wavelength of the laser beam, a fluence, and a spot size.

### Orientation Angle

An “orientation angle” is defined as an angle of a polarization plane of the at least one laser beam with respect to a surface of a section of the coated conductor. In an embodiment, it is preferred to measure the orientation angle with respect to an imaginary axis. In this embodiment, it is preferred to define the smallest angle between the imaginary axis and the polarization plane as the orientation angle. In an embodiment, the polarization plane and a further polarization plane, formed by a mirror-image of the polarization plane around an imaginary axis, are equally preferred. In another embodiment, it is preferred that the imaginary axis is along a length of the coated conductor.

In an embodiment, it is preferred to use a smaller orientation angle for a larger ablation depth, and to use a larger orientation angle for a smaller ablation depth. E.g., for a section with an ablation depth of 10 mm, it is preferred to use an orientation angle of 80°, while for a section with an ablation depth of 20 mm, it is preferred to use an orientation angle of 30°.

### Laser Beam

In an embodiment, it is preferred that the spot size of a laser beam is the length of a diameter of the spot. It is also preferred that a spot is a focal spot. It is more preferred that the spot is about circular. In another embodiment, it is preferred that at least one laser beam is a pulsed laser beam. In this embodiment, it is preferred that the fluence of the at least one laser beam should be understood as the fluence per pulse.

The peak wavelength of a spectrum is a local maximum, in one embodiment in addition a global maxi-mum, of the spectrum. A preferred peak wavelength is a laser wavelength, i.e., a main wavelength of a laser output. The laser wavelength may be a lasing wavelength of a gain medium of the laser or a wavelength which is obtained by a non-linear optical effect, such as frequency doubling, from the lasing wavelength.

### Lasers

In an embodiment, it is preferred that the at least one laser beam is obtainable from at least one solid-state laser. In this embodiment, a gain medium of the at least one solid-state laser is in one embodiment a crystal. In this embodiment, a preferred crystal is doped with neodym. In this embodiment, a preferred neodym-doped crystal comprises yttrium. A preferred crystal which comprises yttrium is selected from the group consisting of Nd:YAG, 15 Nd:Y3Al5,O12, and Nd:YVO4, with Nd:YVO4 being particularly preferred.

Lasers for producing the laser beams of the present embodiment are well-known to a person skilled in the art. Such laser are commercially available from e.g., Photonics Industries International, Inc (USA), or Trumpf GmbH and Co. KG (Germany).

Embodiments are now illustrated by non-limiting examples and exemplifying figures.

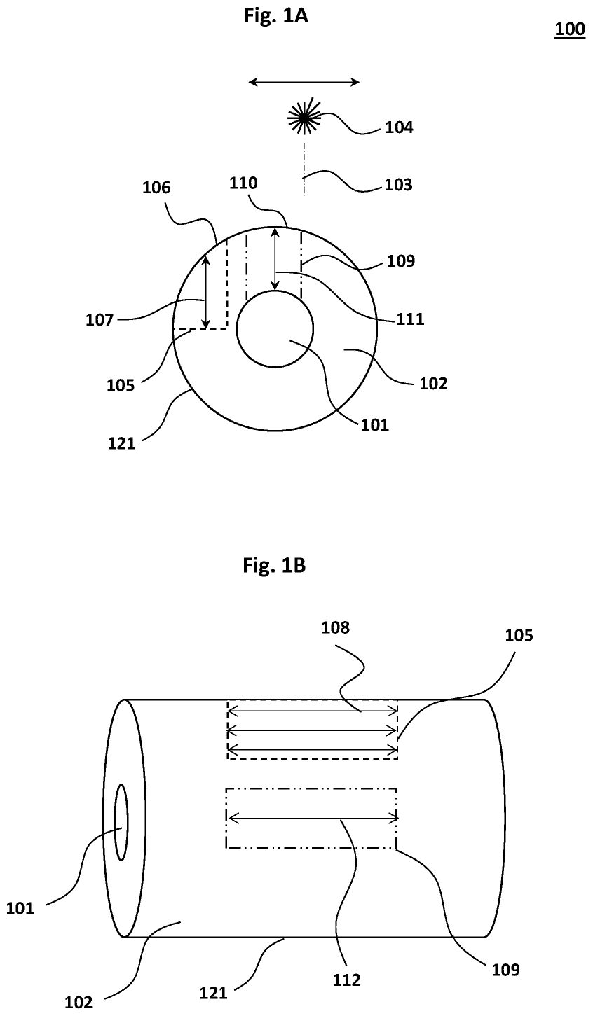

FIG. 1 illustrates a schematic illustration of a first example of the method 100 for producing an ablated conductor by adjusting an energy density of a radiation, produced by a laser beam, that irradiates a surface of a section of a coated conductor. FIG. 1A illustrates a cross-section of a coated conductor 121 that is provided. The coated conductor 121 has an electrically conducting inner layer 101 and a coating layer 102 that surrounds (covers) the inner layer 101. Also provided is a laser beam 103 produced by a laser 104. The laser beam 103 can be moved in the direction as indicated by the arrow above the laser 104. The coating layer 102 is to be removed in a first section 105 indicated by the dashed lines. The first section 105 has a surface 106 and a first ablation depth 107. The coating layer 102 is also to be removed in a further section 109 indicated by the dashed-dotted lines. The further section 109 has a surface 110 and a further ablation depth 111. Furthermore, the first ablation depth 107 is larger than the further ablation depth 111.

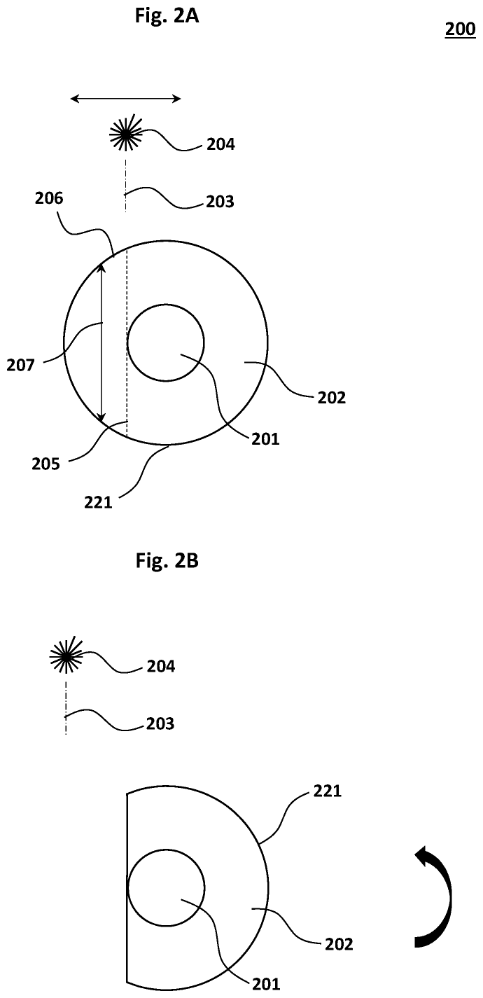

FIG. 1B illustrates the coated conductor 121 viewed from above. The coating layer 102 is removed in the first section 105 by moving the laser beam (not shown) along the scan lines 108. The coating layer 102 is removed in the further section 109 by moving the laser beam along the scan line 112. FIG. 2A illustrates that the first section 105 and the further section 109 have the same length. Furthermore, the number of scan lines in the first section 108 are more than the number of scan lines in the further section 112. Apart from the difference in the number of scan lines between the first section 105 and the further section 109, all other production parameters, e.g., energy per pulse and laser fluence, are kept constant for ablating the coating layer 102 in the sections 105 and 109. Furthermore, the first section 105 and the further section 109 both have the same length and width (the length is measured parallel, and the width perpendicular, to the direction of the scan lines). As the first section 105 has more scan lines, compared to the further section 109, the laser beam that irradiates the surface 106 of the first section 105 has a higher energy density, compared to the energy density of the laser beam that irradiates the surface 110 of the further section 109.

FIG. 2 illustrates a schematic illustration of a second example of the method 200 for producing an ablated conductor by adjusting an energy density of a radiation, produced by a laser beam, that irradiates a surface of a section of a coated conductor. FIG. 2A illustrates a cross-section of a coated conductor 221 that is provided. The coated conductor 221 has an electrically conducting inner layer 201 and a coating layer 202 that surrounds (covers) the inner layer 201. Also provided is a laser beam 203 produced by a laser 204. The laser beam 203 can be moved in the direction as indicated by the arrow above the laser 204. The coating layer 202 is to be removed in a first section 205 indicated by the dashed lines. The first section 205 has a surface 206 and a first ablation depth 207.

FIG. 2B illustrates that the coating layer 202 has been removed partially around the inner layer 201 by moving the laser beam 203 with respect to the coated conductor 221. After this removal, the coated conductor 221 is rotated as indicated in FIG. 2B to obtain the orientation as shown in FIG. 2C. The coating layer 202 is also to be removed in a further section 209 indicated by the dashed-dotted lines. The further section 209 has a surface 210 and a further ablation depth 211. The further ablation depth 211 is less than the first ablation depth 207. The coating layer 202 in the further section 209 is removed in the same manner as the coating layer 202 in the first section 205, with the following exception: a smaller energy density, compared to the energy density used for removing the coating layer 202 in the first section 205, is used for removing the coating layer 202 in the further section 209. Although not shown, the coated conductor 221 can be rotated again and the coating layer 202 can be removed in another section. This procedure can be repeated any number of times.

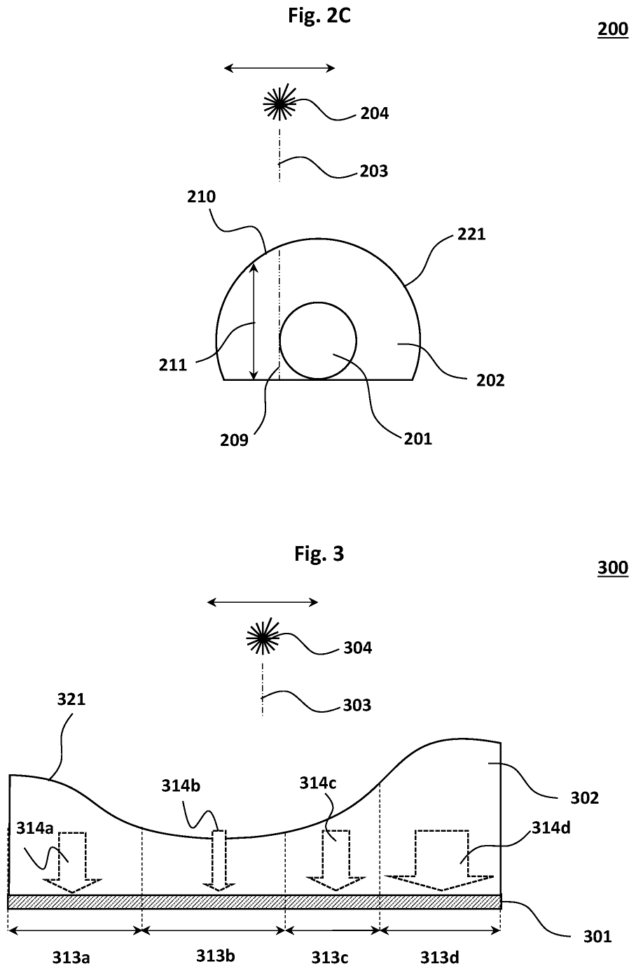

FIG. 3 illustrates a schematic illustration of a third example of the method 300 for producing an ablated conductor by adjusting an energy density of a radiation, produced by a laser beam, that irradiates a surface of a section of a coated conductor. FIG. 3 illustrates a cross-section of a coated conductor 321 that is provided. The coated conductor 321 has an electrically conducting inner layer 301 and a coating layer 302 that covers the inner layer 301. Also provided is a laser beam 303 produced by a laser 304. The laser beam 303 can be moved in the direction as indicated by the arrow above the laser 304. The coating layer 302 is to be completely removed in the four sections 313a, 313b, 313c, and 313d.

In FIG. 3., sections 313a and 313c have the same ablation depth (not shown). Compared to the ablation depth of sections 313a and 313c, section 313d has a larger ablation depth (not shown). Compared to the ablation depth of sections 313a and 313c, section 313b has a smaller ablation depth (not shown). The coating layer 302 in a section is removed by moving the laser beam 303 with respect to conductor along at least one scan line in the section. The width of the dashed arrows, 314a, 314b, 314c, and 314d indicate the number of scan lines used for each section. The same number of scan lines are used for sections 313a and 313c. Compared to sections 313a and 313c, a larger number of scan lines are used for section 313d. Compared to sections 313a and 313c, a smaller number of scan lines are used for section 313b. Apart from the difference in the number of scan lines between the sections, all other production parameters, e.g., energy per pulse and laser fluence, are kept constant for ablating the coating layer 302 in the sections 313a, 313b, 313c, and 313d. A larger number of scan lines therefore means that the laser beam that irradiates a surface of a first section (e.g., 313a) has a higher energy density, compared to the energy density of the laser beam that irradiates a surface of a further section (e.g., 313b) that has a smaller number of scan lines.

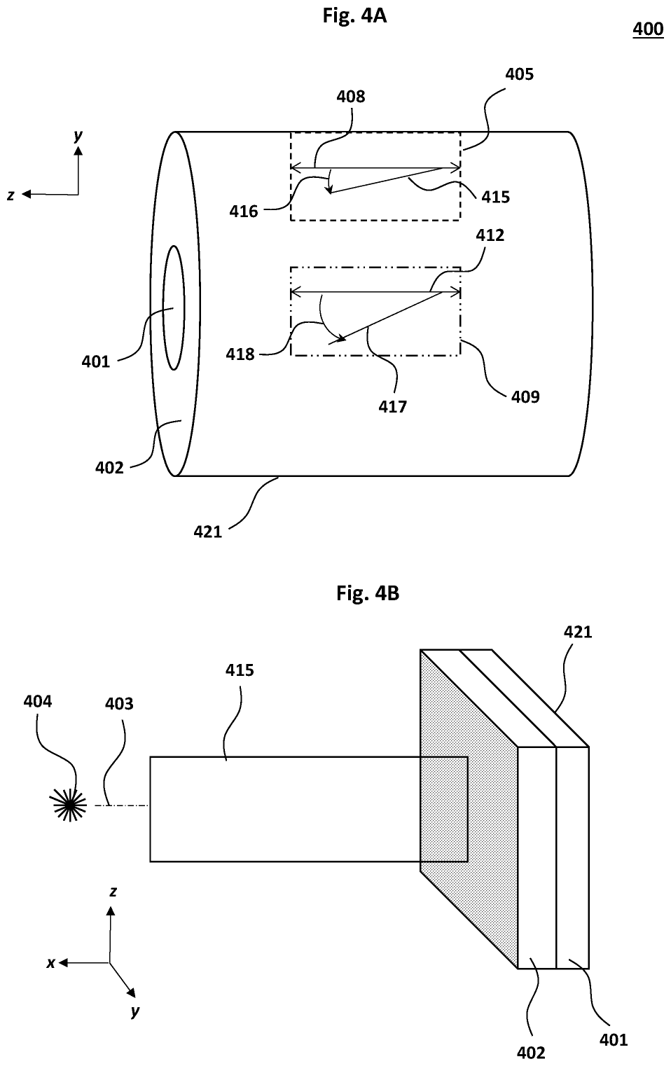

FIG. 4 illustrates a schematic illustration of a first example of the method 400 for producing an ablated conductor by adjusting an orientation angle of the laser beam that irradiates a surface of a section of a coated conductor. FIG. 4A illustrates a provided coated conductor 421 viewed from above. The coated conductor 421 has an electrically conducting inner layer 401 and a coating layer 402 that surrounds (covers) the inner layer 401. Also provided is a laser beam (not shown) that is directed perpendicular to the zy-plane. The coating layer 402 is to be removed in a first section 405, indicated by the dashed lines, and a further section 409, indicated by the dashed-dotted lines. Furthermore, an ablation depth of the first section 405 is larger than an ablation depth of the further section 409. The coating layer 402 is removed by moving the laser beam along scan lines in the first section 408 and scan lines in the further section 412.

FIG. 4A also illustrates a first orientation angle 416 of a first polarization plane 415 of the laser beam with respect to a surface of the first section 405. FIG. 4A further illustrates a further orientation angle 418 of a further polarization plane 417 of the laser beam with respect to a surface of the further section. The further orientation angle 418 is larger than the first orientation angle 416. The orientation angles 416 and 418 are measured with respect to the z-axis, which is arranged along a length of the coated conductor.

FIG. 4B illustrates a schematic illustration of the polarization plane. FIG. 4B illustrates a provided coated conductor 421 viewed from the side. The coated conductor 421 has an electrically conducting inner layer 401 and a coating layer 402 that covers the inner layer 401. Also provided is a laser beam 403 produced by a laser 404. The laser beam 403 is directed along the x-axis, with the polarization plane of the laser indicated by 415.

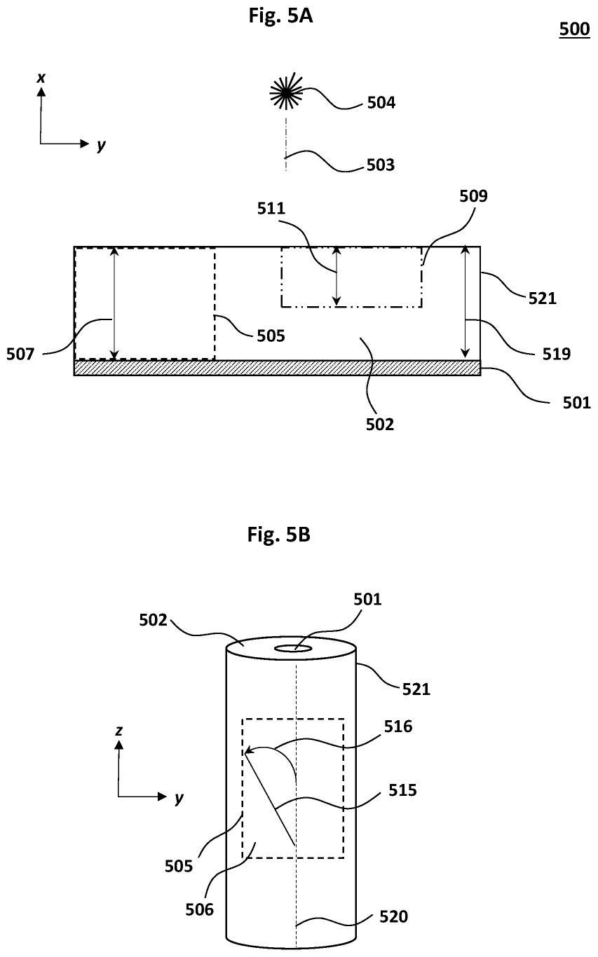

FIG. 5 illustrates a schematic illustration of the definition of the ablation depth and orientation angle. In FIG. 5 a coated conductor 521 with an inner layer 501 and a coating layer 502, covering the inner layer 501, is provided. In FIG. 5A, the coating layer 502 is to be removed in a first section 505, indicated by the dashed rectangle, while the coating layer is to be partially removed in a further section 509, indicated by the dashed-dotted rectangle. The coating layer is to be (partially) removed using the laser beam 503 obtained from the laser 504. FIG. 5A also illustrates that a total thickness 519 of the coating layer 502 is constant. However, a thickness 507 of the coating layer 502 to be removed in the first section 505 is larger than a thickness 511 of the coating layer 502 to be removed in the further section 509. This thickness of the coating layer to be removed is defined as the ablation depth. Furthermore, the ablation depth for both the first section 507 and the further section 511 are measured parallel to the same coordinate axis, i.e., the x-axis.

FIG. 5B illustrates the definition of an orientation angle 516 of a polarization plane 515 of a laser beam that irradiates a surface of a section of a coated conductor. The laser beam (not shown) is directed perpendicular to the zy-plane. A coating layer 502 is to be ablated in a first section 505 of a coated conductor 521. The first section 505 has a surface 506. In FIG. 5B, an orientation angle 516 is the angle between a polarization plane 515 and an imaginary axis 520, where the imaginary axis 520 is along a length of the coated conductor. Furthermore, the orientation angle 516 is measured anti-clockwise. While the orientation angle 516 can also be measured clockwise, it is preferred to define the smallest angle between the imaginary axis 520 and the polarization plane 515 as the orientation angle 516, in this case the angle 516 as shown in FIG. 5B. If the polarization plane were to be orientated such that the polarization plane is the mirror image of the polarization plane 515 around the imaginary axis 520, the magnitude of the orientation angle of the mirror-image would be the same as the magnitude of the orientation angle 516. The orientation of the polarization plane 515 and the orientation of the polarization plane of the mirror-image are equally preferred.

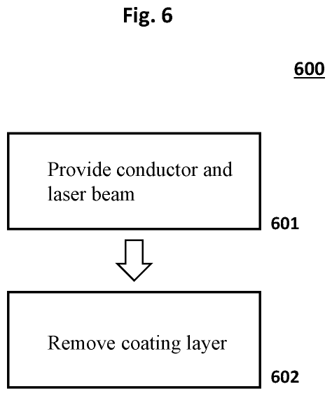

FIG. 6 illustrates a flow diagram illustrating the steps of the method for producing an ablated conductor. In step 601, a coated conductor including an inner layer, that is electrically conducting, and a coating layer, that at least partially covers the inner layer, is provided. In step 601, a laser beam is also provided. In step 602, the coating layer is partially removed in a section by moving the laser beam and the coated conductor with respect to each other along scan lines in the section. Furthermore, an ablation depth of the coating layer in the section is used to adjust either an energy of the laser beam that irradiates a surface of the section, or an orientation angle of the laser beam, or both.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

### EXAMPLES

The embodiments are illustrated further by way of examples. The invention is not restricted to the examples.

For all of the examples, the following applies: a coated conductor, in the form of a coated wire, is provided. The coated conductor has an inner layer that is electrically conducting, an intermediate coating layer that covers the inner layer, and an outermost coating layer that covers the intermediate coating layer. The inner layer consists of platinum clad tantalum, and has a diameter of 100 μm. The intermediate coating layer consists of polyurethane, and has a total thickness of 25 μm. The outermost coating layer comprises polyurethane, silver and silver chloride, and has a total thickness of 15 μm.

A laser beam is provided, wherein the laser beam is produced by a pulsed, Nd:YVO4-laser with a peak output wavelength at 532 nm. This output wavelength is obtained by frequency doubling the lasing wavelength of about 1064 nm of the Nd:YVO4-crystal. The laser beams are pulsed at a frequency of 160 kHz, wherein each pulse has an energy of 5 μJ and a duration of about 60 ns. The laser beam is focused down to a focal beam diameter (spot size) of 15 μm. Each pulse of the laser beam has a fluence of 2.8 J/cm².

The outermost coating layer is to be removed in a first section (e.g., 105 in FIG. 1B) and a further section (e.g., 109 in FIG. 1B), wherein the ablation depth of the first section is 95 μm, and the ablation depth of the further section is 15 μm. The first section and the further section both have a length of 15 mm and width of 60 mm.

The scan lines in the first section, as well as the scan lines in the further section, are arranged parallel to an imaginary axis that is along the length of the coated conductor. An orientation angle of the laser beam is also measured with respect to the same imaginary axis. The outermost coating layer is removed in the first section and the further section by moving the laser beam with respect to the coated conductor along the scan lines in a respective section.

### Example 1 (Comparative)

In this example, the first section and the further section both have the same number of scan lines, as well as the same orientation angle of the polarization plane of the laser beam. The number of scan lines in each section is 5. Furthermore, for both sections the orientation angle is 72°.

### Example 2 (According to One Embodiment)

In this example, the first section and the further section have the same orientation angle of 72°. However, the number of scan lines in the first section is 10, while the number of scan lines in the further section is 5.

### Example 3 (According to One Embodiment)

In this example, the first section and the further section have the same number of scan lines, in this case 5. However, the orientation angle in the first section is 35°, while the orientation angle in the further section is 85°.

Table 1 summarizes a comparison of Examples 1 to 3. It can be seen that Examples 2 and 3, according to the present embodiment, provided numerous technical benefits over Example 1, which is not according to the present embodiment.

TABLE 7
comparison of the technical effects of Examples 1 to 3.

| | Example 1 | | Example 2 | | Example 3 | |
|---|---|---|---|---|---|---|
| | First | Further | First | Further | First | Further |
| | section | section | section | section | section | section |
| Damage to | ++ | −− | ++ | + | ++ | + |
| non-ablated | | | | | | |
| layers | | | | | | |
| Overheating | − | − | ++ | ++ | + | ++ |
| of inner | | | | | | |
| layer | | | | | | |
| Ablation | −− | +++ | ++ | +++ | +++ | +++ |
| depth | | | | | | |
| removed | | | | | | |
| Set-up time | −− | −− | ++ | ++ | + | + |
| Energy | − | − | − | + | + | + |
| consumption | | | | | | |

| | | | |
|---|---|---|---|
| Uniform | −− | ++ | ++ |
| thickness | | | |
| required | | | |
| Production | − | + | + |
| time | | | |
| Failure rate | + | +++ | +++ |
| Precision | + | ++ | +++ |
| Lifetime | + | +++ | ++ |

In the above table, the more “+”, the better the method can achieve the desired effect. Conversely, the more “−”, the less the desired effect is achieved.
Damage to non-ablated layers: damage caused by the laser beam to the inner layer and intermediate coating layer due to the removal of the outermost coating layer. It is desired to reduce the damage.
Overheating of inner layer: the removal of the outermost coating layer can lead to an overheating of the inner layer. It is desired to reduce the overheating.
Ablation depth removed: whether the thickness of the outermost coating that was removed in a section is equal to, or smaller than, the ablation depth of the section. A smaller thickness indicates that not all of the required outermost coating layer was removed in the section. It is desired that the ablation depth is removed.
Set-up time: time required to set up the method for producing an ablated conductor when the ablation requirements change. It is desired that the set-up time is reduced.
Energy consumption: the energy consumption when the method for producing an ablated conductor is performed. It is desired that the energy consumption is reduced.
Uniform thickness required: whether it is required that the total thickness of a coating layer should be uniform in order for the method for producing an ablated conductor to be usable. It is desired that a uniform thickness is not required.
Production time: time required to produce the ablated conductor. The production time includes the time required for performing quality assurance checks. It is desired that the production time is reduced.
Failure rate: the number of ablated conductors that fail quality control tests. These tests include, e.g., test of the conductivity of the different layers of the wire. It is desired that the failure rate is reduced.
Precision: the accuracy of the measurements when the ablated conductors are used as electrochemical sensors. It is desired that the precision is increased.
Lifetime: the service lifetime of the ablated conductors, i.e., the number of hours an ablated conductor can be used before failure. It is desired that the lifetime is increased.

### Test Methods

The test methods which follow were utilized within the context of the embodiments. Unless stated otherwise, the measurements were conducted at an ambient temperature of 23° C., an ambient air pressure of 100 kPa (0.986 atm), and a relative air humidity of 50%.

### Energy Density

The energy density, Eᵣ, of a radiation, produced by a laser beam, that irradiates a surface of a section of the coated conductor is calculated as follows:

Eₚ=Eₜₒₜ/A,

where Eₜₒₜ is the total energy that irradiates the surface of the section of the coated conductor, and A is the surface area of the section. For a pulsed laser beam, the total energy Eₜₒₜ is calculated by where Eₙ is the energy of the n^{th} pulse, and the sum is calculated over the n pulses that are used to

$${E}_{tot} = {\sum }_{1}^{n} {E}_{n} ,$$

irradiate the section. For a non-pulsed laser beam, the total energy Eₜₒₜ is calculated by

$${E}_{tot} = {\sum }_{1}^{n} {P}_{n} {t}_{n} ,$$

where Pₙ is the power of the laser beam used the scan the n^{th} scan line in the section, and tₙ is the time required to scan the n^{th} scan line. The sum is taken over the n scan lines in the section.

### Average Distance Between Adjacent Scan Lines

The average distance between adjacent scan lines in a section is calculated by first summing the distance between each pair of adjacent scan lines in the section, and then dividing the sum by the number of scan lines−1 in the section.

### Spectrum and Peak Wavelength

In case of a laser beam as beam of electromagnetic radiation, the peak wavelength of the spectrum is the nominal peak wavelength of the laser output. This is either the wavelength at which the laser, which produces the laser beam, lases or, if a non-linear optical process is used to alter the output wavelength, the respective harmonic of the lasing wavelength. For example, a KrF-Excimer laser typically has a lasing wavelength at about 248 nm. A Nd:YVO4-laser typically has a lasing wavelength at about 1064 nm. If the light of the Nd:YVO4-laser is frequency doubled, the peak wavelength of the laser output is at about 532 nm. If the beam of electromagnetic radiation is not a laser beam, the spectrum of this electromagnetic radiation is measured using a spectrometer of the type CCS200 from Thorlabs GmbH. The measurement is conducted in accordance with the manufacturer's instructions. The peak wavelength of the measured spectrum is then a local maximum of the spectrum which is also its global maximum.

### Pulse Frequency

The pulse frequency is defined as the number of pulses, emitted per unit of time. The pulse frequency of a pulsed laser beam is adjusted at the laser producing the laser beam. Any pulse frequency, referred to herein, means the pulse frequency as adjusted at the laser producing the laser beam.

### Pulse Duration

The pulse duration is defined as the time duration between the intensity levels of a pulse measured at FWHM (full width at half-maximum). It is measured with a suitable photo diode and an oscilloscope.

### Fluence

The fluence is defined as energy per pulse [J]/effective focal spot area [cm²]. Therein, the effective focal spot area is calculated as the area of a circle of a diameter which is the spot size according to the test method below.

### Energy Per Pulse

The energy per pulse is determined by first measuring the accumulated energy of the laser beam over a period of irradiation of 1 second using a thermal power meter. If the focus of the laser beam is on the workpiece, this energy is measured right in front of the workpiece, i.e., slightly out of the focus point. The pulse frequency is determined as described above. The energy per pulse is calculated by dividing the accumulated energy by the pulse frequency in Hz.

### Spot Size

The 2D-intensity distribution of the spot is measured using a 2D power meter. The spot size is determined by fitting a circle to the Full Width at Half Maximum of the 2D-intensity distribution. The spot size is the diameter of this circle.

### Weight Percentage

This is determined by quantitative analytical methods. E.g., gas chromatography, gravimetry, elementary analysis or the like.

### Electrical Conductivity

Electrical conductivity is measured according to the standard ASTM B193-16.

### Damage to Non-Ablated Layers and Ablation Depth Removed

Sets of photographs are taken along the length of the coated wire, wherein each set consists of four photographs taken around the circumference of the wire. Furthermore, the four photographs in each set are taken at the same position along the length of the coated wire.

Sections where the non-ablated layers (the inner layer and the intermediate layer) are damaged are visible in the photographs, and are distinguishable from sections where the non-ablated layers are not damaged. Similarly, from the photographs it is also possible to distinguish between sections where the thickness of the outermost coating (that was removed) is less than the ablation depth, and sections where the thickness of the outermost coating (that was removed) is equal to the ablation depth.

An imaginary grid is overlaid onto the photographs, with the grid used to calculate the surface area of the sections where the non-ablated layers are damaged. The grid is also used to calculate the surface area of the sections where the outermost coating (that was removed) is less than the ablation depth. A decrease in these surface areas, when comparing examples 2 and 3 with comparative example 1, allows one to calculate the improvement of examples 2 and 3 over comparative example 1.

1. A method for producing an ablated conductor, comprising:
a.) providing
i.) a coated conductor comprising:
A.) an inner layer that is electrically conducting; and
B.) at least one coating layer that at least partially covers the inner layer;
ii.) at least one laser beam;
b.) at least partially removing the at least one coating layer in a first section by moving the at least one laser beam and the coated conductor with respect to each other along at least one scan line in the first section;
wherein a first energy density of a first radiation, produced by the at least one laser beam, that irradiates a surface of the first section is adjusted according to a first ablation depth of the first section.

2. The method according to claim 1, wherein the first energy density is adjusted by adjusting the number of scan lines in the first section.

3. The method according to claim 1, wherein the first energy density is adjusted by adjusting the fluence of the at least one laser beam that irradiates the surface of the first section.

4. The method according to claim 1, further comprising at least partially removing the at least one coating layer in a further section by moving the at least one laser beam and the coated conductor with respect to each other along at least one scan line in the further section, and wherein a further energy density of a further radiation, produced by the at least one laser beam, that irradiates a surface of the further section is adjusted according to a further ablation depth of the further section.

5. The method according to claim 4, wherein at least one or all of the following applies:
a.) the further energy density is adjusted by adjusting a number of scan lines in the further section;
b.) the further energy density is adjusted by adjusting a fluence of the at least one laser beam that irradiates the surface of the further section.

6. The method according to claim 4, wherein at least one or all of the following applies:
a.) at least one physical dimension of the first section is less than 5% larger than the corresponding physical dimension of the further section;
b.) the first ablation depth is in the range of 50% to 650% larger than the further ablation depth;
c.) the first energy density is in the range of 50% to 350% larger than the further energy density;
d.) the number of scan lines in the first section is at least 1.5 times larger than the number of scan lines in the further section;
e.) the fluence of the laser beam in the first section is at least 50% larger than a fluence of the larger beam in the further section.

7. The method according to claim 1, further comprising rotating the coated conductor.

8. The method according to claim 1, wherein the at least one laser beam is a polarized laser beam.

9. The method according to claim 8, wherein at least one or all of the following applies:
a.) a first orientation angle of the at least one laser beam, that irradiates a surface of the first section, is adjusted according to the first ablation depth of the first section;
b.) the first orientation angle is in the range of 0° to 82°;
c.) a further orientation angle of the at least one laser beam, that irradiates a surface of the further section, is adjusted according to the further ablation depth of the further section;
d.) the further orientation angle is in the range of 35° to 90°;
e.) the first orientation angle is at least 20% smaller than the further orientation angle.

10. The method according to claim 1, wherein the coated conductor comprises at least two coating layers, and wherein the at least two coating layers are at least one intermediate coating layer and an outermost coating layer, and wherein at least one or all of the following applies:
a.) the at least one intermediate coating layer at least partially covers the inner layer;
b.) the outermost coating layer at least partially covers the at least one intermediate coating layer.

11. The method according to claim 1, wherein the inner layer has at least one or all of the following properties:
a.) comprises one or more metals selected from the group consisting of gold, platinum, copper, silver, tantalum, and stainless steel;
b.) a thickness in the range of 40 μm to 160 μm;
c.) an electrical conductivity in the range of 10⁴ S/m to 10⁸ S/m.

12. The method according to claim 10, wherein the at least one intermediate coating layer has at least one or all of the following properties:
a.) a thickness in the range of 10 μm to 40 μm;
b.) comprises a polymer;
c.) an electrical conductivity in the range of 10⁻²¹ S/m to 10⁻¹¹ S/m.

13. The method according to claim 10, wherein the outermost coating layer has at least one or all of the following properties:
a.) comprises at least 10 wt. %, based on the total weight of the outermost layer, of an organic material;
b.) comprises 50 wt. %, based on the total weight of the outer layer, of a metal or a metal compound, or a combination thereof;
c.) a thickness in the range of 6 μm to 24 μm;
d.) an electrical conductivity in the range of 10⁻⁸ S/m to 2×10⁻² S/m.

14. The method according to claim 13, wherein the organic material is a polymer selected from the group consisting of:
a.) a mixture comprising an electrically insulating polymer and a plurality of particles that comprises a metal or a metal compound, or a combination thereof;
b.) a conductive polymer; or
c.) a combination of a.) and b.).

15. The method according to claim 1, wherein at least one laser beam is a laser beam of the first kind, wherein a laser beam of the first kind has at least one or all of the following properties:
a.) a pulse duration in the range of 10 fs to 500 ns;
b.) a pulse frequency in the range of 5 kHz to 600 kHz;
c.) an energy per pulse in the range of 2 μJ to 15 μJ;
d.) has a spectrum with a peak wavelength in the range of 430 nm to 780 nm;
e.) a fluence in the range of 1.0 J/cm² to 5.0 J/cm²;
f) a spot size in the range of 5 μm to 50 μm.

16. The method according to claim 1, wherein at least one laser beams is a laser beam of the further kind, wherein a laser beam of the further kind has at least one or all of the following properties:
a.) a pulse duration in the range of 10 fs to 500 ns;
b.) a pulse frequency in the range of 1 kHz to 100 kHz;
c.) an energy per pulse in the range of 1 μJ to 50 μJ;
d.) has a spectrum with a peak wavelength in the range of 10 nm to 430 nm;
e.) a fluence in the range of 0.1 J/cm² to 50.0 J/cm²;
f) a spot size in the range of 2 μm to 50 μm.

17. An ablated conductor obtainable by the method according to claim 1.

18. A use of the ablated conductor according to claim 17 in an electrical device.

19. A use of the ablated conductor according to claim 17 as a sensor.

20. An electrical device comprising a further electronic element that is in electrical contact with an ablated conductor according to claim 17.
